(19) United States
(12) Patent Application Publication
(10) Pub. No.: US 2007/0013205 A1
(43) Pub. Date: Jan. 18, 2007

(54) Surface for a vehicle cockpit

(75) Inventor: Thomas Heck, Mainz-Laubenheim (DE)

Correspondence Address: COHEN, PONTANI, LIEBERMAN & PAVANE, 551 FIFTH AVENUE, SUITE 1210, NEW YORK, NY, 10176, US

(73) Assignee: Siemens Aktiengesellschaft, Munchen (DE)

(21) Appl. No.: 11/485,581

(22) Filed: Jul. 12, 2006

(30) Foreign Application Priority Data
Jul. 13, 2005 (DE) 10 2005 032 707.9

(51) Int. Cl. B62D 25/14; B32B 27/04

(52) U.S. Cl. 296/70; 428/297.4; 428/411.1

(57) ABSTRACT

At least one element of a vehicle cockpit is provided with a superhydrophobic surface, so that this element can be cleaned easily. On the one hand, contamination by liquids is fully avoided and, on the other hand, dirt due to dust and other particles can easily be removed with water.

### BACKGROUND OF THE INVENTION

1. Field of the Invention

The invention relates to a surface of at least one element of a vehicle cockpit.

2. Description of the Related Art

In vehicles such as automobiles or trucks, or sports and sailing ships, the surfaces of the cockpit are usually formed by wood, leather or plastic materials. In some cases, textiles are also used to form the surface. In this context, the term cockpit is intended to mean the region of the vehicle interior where the equipment used for driving the vehicle is fitted together with the relevant operating and display units, and the elements of the cockpit are the individual cladding and covering units which enclosed this equipment.

A problem is the inevitable contamination of the cockpit surface by dust or dirt which, for example, is caused by the vehicle driver or passengers. For vehicles in which the cockpit is fully or partially unprotected from the external environment, for example in cabriolets, the additional contamination by the outside air adds to this. Dirt is conventionally removed from cockpit surfaces by using chemical cleaning agents, which is sometimes time-consuming especially when not all the visible surfaces of the cockpit are easy to reach by hand. There is also a risk that excessive rubbing or too aggressive cleaning agents will leave scratch marks behind on the surface.

### SUMMARY OF THE INVENTION

An object of the present invention is to provide a surface for at least one element of a vehicle cockpit, by which said problems due to dirt are reduced.

This object is achieved by a surface which is superhydrophobic.

The term superhydrophobic surface is intended to mean a surface which has a contact angle of more than 120° with respect to water. The contact angle is in this case the angle between the surface, on which there is a drop of liquid, and the outer skin of the liquid drop, the size of the contact angle being determined by the interaction between the liquid and the solid of the surface. When there is a contact angle of more than 90° with respect to water, the water forms an approximately hemispherical drop. The greater the contact angle is, the more the water drop approximates a spherical shape, i.e. the better the water rolls off the surface. The term lotus effect is also used for very high contact angles of more than 160°.

The superhydrophobic surface configuration according to the invention offers the advantage that dirt caused by liquids will adhere less or not at all on the surface. Dust and other solid dirt particles can furthermore be removed very easily with water, since the water rolling off from the surface absorbs these particles and takes them with it. It is no longer necessary to add cleaning agents, or to use mechanical means for releasing the dirt particles. The surface is thus protected and cleaning it is significantly facilitated for the user.

In one configuration of the invention, the visible surface of at least one element of the vehicle cockpit, predominantly aligned horizontally in the vehicle and having a large visible surface, is designed to be superhydrophobic. This ensures that at least the element which is contaminated most rapidly owing to the horizontal alignment, and whose dirt impairs the visual appearance of the vehicle cockpit, is particularly simple to clean or even not at all susceptible to contamination. In one refinement, the visible surfaces of all fully or partially visible elements of the vehicle cockpit are designed to be superhydrophobic.

As an alternative, the visible surfaces of all fully or partially visible elements of the vehicle cockpit which are difficult to reach by hand are designed to be superhydrophobic. This proves advantageous when special customer wishes, which do not make it viable to use a superhydrophobic surface for all the visible elements, are to be taken into account in respect of the design or configuration of the vehicle cockpit. The visible elements which are difficult to reach generally influence the nature of the configuration of a vehicle cockpit only insubstantially, but on the other hand constitute a problem for cleaning which can be alleviated in this way.

In one configuration of the invention, the surface is formed by a superhydrophobic coating, in particular a superhydrophobic varnish layer. Such a coating can be applied onto the corresponding elements of the vehicle cockpit subsequently after production, and even after assembly of the vehicle cockpit. For example, this may be done by a spray method. Subsequent application allows individual configuration of the vehicle cockpit with superhydrophobic elements or even subelements, and furthermore makes it possible to upgrade cockpits already installed in vehicles by providing them with superhydrophobic surfaces.

In an alternative configuration, the superhydrophobic surface is formed by a plastic which forms a superhydrophobic outer layer owing to addition of structuring particles. This configuration offers the advantage that no additional production step is necessary for rendering the surface hydrophobic, rather the structuring particles are added to the plastic material actually before the cockpit element shaping method, for example injection molding. Materials which form a structure with irregularities in the micro to nanometer range on the outer layer of the cockpit element after curing are suitable for this, as described in U.S. Pat. No. 6,660,363.

In another configuration, the superhydrophobic surface consists of a plastic whose outer layer has been provided with a superhydrophobic structure during a shaping method. Surface structuring which leads to the superhydrophobic property can thus be ensured by appropriate configuration of the tools used for the shaping method.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be explained in more detail below with reference to an exemplary embodiment and the drawing, in which:

FIG. 1 is a sectional side view of a hydrophobic surface with a drop of water;

FIG. 2 is a sectional side view of a superhydrophobic surface with a drop of water; and

FIG. 3 shows a vehicle cockpit with superhydrophobic elements.

### DETAILED DESCRIPTION OF THE PRESENTLY PREFERRED EMBODIMENTS

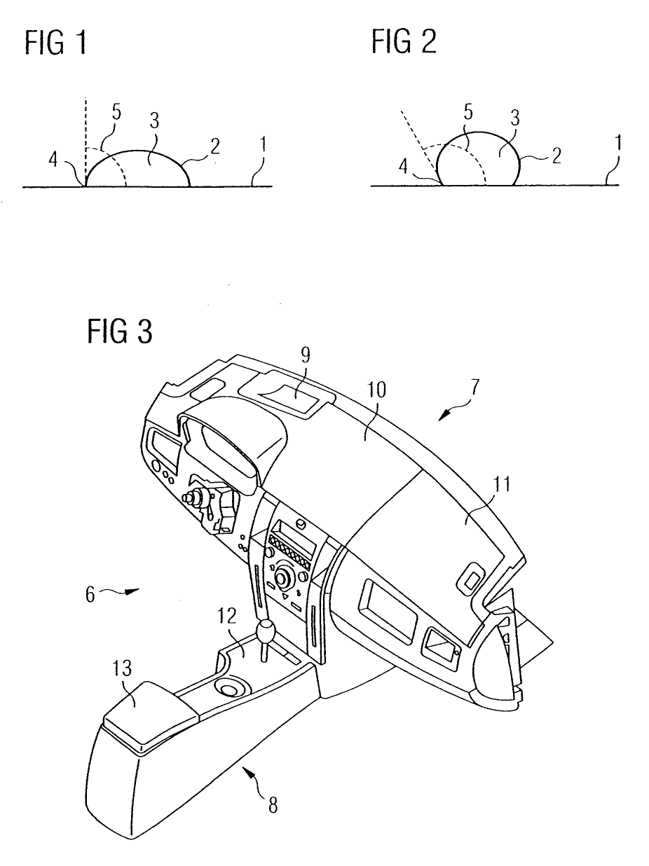

At the point of contact 4 between the outer skin 2 and the surface 1, the surface 1 depicted in FIG. 1 makes a contact angle 5 of 90 degrees with the outer skin 2 of the water drop 3 lying on it. This surface 1 is referred to as hydrophobic, as are surfaces with a contact angle 5 greater than this. The water drop 3 then approximately assumes the shape of a bowl or hemisphere.

If the content angle 5 reaches a value of 120 degrees as represented in FIG. 2, or exceeds this value, then it is a superhydrophobic surface 1. As can be seen clearly in FIG. 2, the shape of the water drop 3 gradually tends toward a pure spherical shape, so that the water drop 3 rolls easily off from the surface 1. During such a rolloff process, dirt particles lying on the surface 1 are absorbed by the water drop 3 and taken with it.

FIG. 3 shows a vehicle cockpit 6 of an automobile, consisting essentially of a dashboard 7 and a central console 8. The visible surfaces of the elements 9, 10 and 11 of the dashboard 7 and the visible surface of the elements 12 and 13 of the central console are designed as superhydrophobic surfaces, since these elements 9 to 13 are predominantly aligned horizontally in the vehicle and each of them has a large visible surface which is particularly exposed to dust and dirt particles.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An element of a vehicle cockpit comprising a surface that is superhydrophobic.

2. The element of claim 1, wherein the surface is a visible surface in the vehicle cockpit and designed to be aligned essentially horizontally in the vehicle.

3. The element of claim 1, further comprising elements of all visible and partially visible surfaces of the vehicle cockpit, wherein each of the visible and partially visible surfaces is superhydrophobic.

4. The element of claim 1, further comprising elements of all visible and partially visible surfaces of the vehicle cockpit that are difficult to reach by hand, wherein each of the visible and partially visible surfaces that are difficult to reach by hand is superhydrophobic.

5. The element of claim 1, wherein the surface is formed by a superhydrophobic coating.

6. The element of claim 1, wherein the coating is a varnish layer.

7. The element of claim 1, wherein the surface is formed by a plastic which includes structuring particles forming a superhydrophobic outer layer.

8. The element of claim 1, wherein the surface consists of a plastic having an outer layer provided with a superhydrophobic structure during a shaping method.

9. A vehicle cockpit comprising a plurality of elements, wherein at least one visible surface on at least one of the plurality of elements is superhydrophobic.

10. The vehicle cockpit of claim 9, wherein the at least one visible surface comprises the visible surfaces of all visible or partially visible elements of the vehicle cockpit.

11. The vehicle cockpit of claim 9, wherein the at least one visible surface comprises the visible surfaces of the vehicle cockpit that are difficult to reach manually.

12. The vehicle cockpit of claim 9, further comprising at least one of a dashboard and a center console, the plurality of elements comprising parts of the at least one of a dashboard and a center console.
